(19) United States
(12) Patent Application Publication
(10) Pub. No.: US 2017/0164742 A1
(43) Pub. Date: Jun. 15, 2017

(54) LUXURIOUS MOTORIZED POOLSIDE LOUNGER AND RELATED SYSTEM

(71) Applicant: Ronny Hay, Chatsworth, CA (US)

(72) Inventor: Ronny Hay, Chatsworth, CA (US)

(21) Appl. No.: 15/372,096

(22) Filed: Dec. 7, 2016

Related U.S. Application Data
(60) Provisional application No. 62/265,844, filed on Dec. 10, 2015.

(51) Int. Cl. A47C 1/14; A47C 1/028; A47C 11/00; A47C 31/00; A47C 1/03; A47C 1/024; A47C 31/11; A47C 7/66; A47C 7/74; A47C 7/72; A47C 7/00; A47C 7/14; E05B 65/00; G06Q 30/06; G06Q 10/02; G06Q 20/40; A47B 83/02

(52) U.S. Cl. CPC A47C 1/143; A47B 83/02; A47C 1/028; A47C 11/005; A47C 31/00; A47C 1/03; A47C 1/0242; A47C 31/113; A47C 1/0244; A47C 1/024; A47C 7/66; A47C 7/744; A47C 7/72; A47C 7/006; A47C 7/14; E05B 65/0075; G06Q 30/0645; G06Q 10/02; G06Q 20/401

(57) ABSTRACT

A luxurious motorized outdoor pool chaise lounge and luxurious motorized outdoor pool seat recliner are provided. The lounge chair and the recliner are fully motorized and include many other luxurious features. The lounge and recliner may be reserved in advance and rented on a time-of-use basis.

### CROSS-REFERENCES TO RELATED APPLICATIONS

This application claims priority from U.S. Provisional Application No. 62/265,844, filed Dec. 10, 2015, which is incorporated by reference in its entirety.

### BACKGROUND

The present invention generally relates to luxurious, motorized pool lounges. More particularly, the present invention relates to a luxury, outdoor, motorized pool chaise lounge and seat recliner, and a related reservation system.

Many people like to lay by the pool, whether in private residences or as guests in public facilities, such as hotels, clubs, cruises, etc. It is very common that the management of public facilities provide basic pool-side lounge chairs, free of charge. Most of these common lounge chairs include a manually adjustable backrest, but lack any motorized functionalities and other luxurious features.

It is also very common that vacationers who are staying in hotels or resorts frequently have difficulty finding available lounge chairs in prime locations. In many cases, people have to start their search for lounge chairs very early in the morning in order to secure lounge chairs in a desirable location by the pool.

Therefore, there is a need for luxury outdoor pool chaise lounges and luxury outdoor pool-seat recliners to fulfill the luxurious desires of users seeking to lie by the pool in a private residence and of vacationers in public facilities who are willing to pay the premium for more comfort, convenience, and for the ability to reserve the lounge or recliner in advance. The present invention meets these and other needs.

### SUMMARY OF THE INVENTION

The present invention provides for a luxury, outdoor, pool chaise lounge chair and recliner which feature motorized and mechanical functionalities, extraordinary comfort, an air cooling system and many other convenient features. In a first embodiment, the present invention is in the form of a lounge chair which allows the user to sit and rest his or her legs on the chair.

In a similar, second embodiment, the present invention is in the form of an outdoor pool seat recliner which allows the user to sit on its sitting surface while resting his or her legs on the floor in front of the outdoor pool seat recliner, or to alternatively recline backward.

The lounge chair and recliner of the present invention includes a comforting design and attractive appearance, and provide some or all of the following luxurious features: at least one motorized backrest for each user with adjustable armrests, a motorized canopy with short and long extension capability, a mist system, a fan or airflow/AC cooling system, a swamp cooling system, a lock-box or locker for valuable items, an icebox, a USB connection to charge personal devices such as personal hand-held devices, mobile phones and computers, built-in speakers, a unified tethered side table, an internet hot spot, a mechanical or electronic service-call request system, and a massage and/or a vibration system. Such systems may be connected to a dedicated internal power source and may be limited to operate for short segments of time.

Additionally, the present invention further allows customers to reserve the lounge chair and recliner in advance and pre-pay for them online using a provided backbone network and website.

The lounge chair and recliner include an on/off switch. When the switch is turned off, the electrical system is shut down and the lounge chair and recliner may be turned off and stored. A customized cover may be used to protect the stored lounge chair and recliner.

Depending on the venue, the lounge chair and recliner can be rented on a “time of use” basis for a fee, or may be available free of charge.

Each single or double user, luxury, outdoor, pool chaise lounge chair and recliner is built and configured with a water isolation and liquid drainage mechanism to avoid user electrocution and to protect the lounge chair and recliner's electrical mechanisms.

The operations of the lounge chair and recliner are controlled by an electronic operating system that uses low voltage self-contained rechargeable DC batteries to operate. The lounge chair and recliner may also include an operating system that can be configured to communicate with a remote server via wireless communication, to activate and deactivate the lounge chair and recliner according to preset schedule and procedures, and to activate the lounge chair and recliner only after the user enters a proper activation code into the chair's electronic system.

The lounge chair may include two separately installed backrests, one in each side of the chair, to allow the user to switch his/her sitting direction without turning the entire chair. The recliner may also include a leg-rest extender.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a perspective view of a first embodiment of the poolside lounger of the present invention in the form of a single-seat lounge chair.

FIG. 2 is an alternate perspective view of the poolside lounger of FIG. 1.

FIG. 3 is a perspective view of the poolside lounger of FIG. 1 in which the motorized canopy is fully retracted.

FIG. 4 is a perspective view of the poolside lounger of FIG. 1 in which the motorized canopy fully extends towards the front end of the poolside lounger.

FIG. 5 is an alternate perspective view of the poolside lounger of FIG. 1 further including a motorized fan.

FIG. 6 is a perspective view of the poolside lounger of FIG. 1 in its inactive mode in which both backrests have been folded towards each other to be unusable.

FIG. 7 is an alternative perspective view of the poolside lounger of FIG. 1, varied to take the form of a double-seat lounge chair.

FIG. 8 is a perspective view of the poolside lounger of FIG. 7, further illustrating the motorized canopy and air conditioning vents.

FIG. 9 is a perspective view of the poolside lounger of FIG. 1, illustrating a laying deck frame with the cushions removed.

FIG. 10 is a perspective view of the laying deck frame referenced in FIG. 9.

FIG. 11 is a perspective view of the poolside lounger of FIG. 1, illustrating a push bar handle for locking movement of wheels underneath the poolside lounger.

FIG. 12 is a perspective view of the poolside lounger of FIG. 1, in which the laying deck has been removed for clarity to illustrate the upper skin of the poolside lounger.

FIG. 13 is a perspective view of the poolside lounger illustrated in FIG. 12 in which the push bar handle has been pressed down to lock a wheel locking mechanism underneath.

FIG. 14 is a perspective view of the poolside lounger illustrated in FIG. 12 in which side skins of the poolside lounger have been removed for clarity to illustrate the main frame structure underneath the upper skin.

FIG. 15 is a perspective view of the poolside lounger of FIG. 1 in which the laying deck, upper skin, and access doors have been removed for clarity to illustrate the internal components of the poolside lounger, including individual component compartments, wheel housings, a water tank, a water drainage system, and a motorized fan in its retracted configuration.

FIG. 16 is a perspective view of the poolside lounger illustrated in FIG. 14 in which the upper skin as well as the side skins have been removed for clarity to illustrate the air conditioning system inside the main frame structure of the poolside lounger.

FIG. 17 is a partial perspective view of a motorized system for the backrests in the poolside lounger of FIG. 1.

FIG. 18 is a partial perspective view of a motorized system for the canopy in the poolside lounger of FIG. 1.

FIG. 19 is a partial perspective view of the motorized canopy in the poolside lounger of FIG. 1.

FIG. 20 is a partial perspective view of the motorized gear system for the backrests in the poolside lounger of FIG. 1.

FIG. 21 is a perspective view of a second embodiment of the poolside lounger of the present invention in the form of a recliner including a motorized back panel and a leg-rest extender.

FIG. 22 is a perspective view of the poolside lounger of FIG. 21 in which the back panel has been retracted and the leg-rest extender has been extended.

FIG. 23 is a partial perspective view of the wheel locking mechanism for the poolside lounger of FIGS. 1 and 21 including the push bar handle.

### DETAILED DESCRIPTION OF THE PREFERRED EMBODIMENTS

As shown in the accompanying drawings, for purposes of illustration, the present invention provides for a luxury, outdoor, motorized pool chaise lounge chair in one embodiment, and a luxury, outdoor, motorized pool seat recliner in a second embodiment (together referred to herein as “poolside lounger” or “PLS”).

Although the poolside lounger of the present invention can be used in private homes or within any outdoor environment, the main target usage of the present invention is in pool areas of public facilities, where the poolside loungers can be rented on a time of use basis. The lounge chair and recliner are fully motorized and provide luxurious comfort including motorized backrests, a motorized canopy, an air-flow or air condition cooling system, a mist system, designer laying cushions, a valuable locker, an ice box, a charger for personal equipment, internet connectivity, speakers, a tethered side table and a waiter's service calling mechanism.

The PLS of the present invention is electrically motorized by utilizing rechargeable batteries or by using a direct DC low voltage source system, as opposed to the high voltage AC power source commonly used for similar equipment. The PLS is primarily designed as an outdoor lounger and recliner that is likely to be placed near swimming pools and other water activity sites and is likely to come into contact with water from users; therefore, the use or the connectivity to high voltage AC power source is not recommended.

When a person's skin is dry, it has a lot of electrical resistance, which is measured in ohms. When a person's skin is wet, the skin's electrical resistance drops significantly. Therefore, when an individual with wet skin is electrocuted, the amount of electrical current flowing through the body, measured in amps, increases, and the resistance, measured in ohms, decreases. When a person's skin is wet and 120 volts of electricity flow across that person's body, it is very likely that a current of at least 100 mA will flow through that person's heart, which can cause ventricular fibrillation and possibly death. Therefore, connecting the PLS to a live, high voltage AC power source, especially while the PLS is in use, poses a liability risk of high voltage electrocution and could be considered a risk endangerment.

To prevent against such risks, the PLS has been innovatively designed to operate utilizing its own contained heavy-duty, low voltage DC rechargeable batteries. The PLS's batteries are designed to be easily removed and reinstalled, so as to allow frequent charging.

The preferred method for charging the batteries, according to this invention, is through the use of external central charging stations (referred to as ECCS). When a single or multiple PLS are located within a designated area, one or more ECCS may be placed within or nearby the area. When the PLS's battery strength light indicator shows a low charge, the weak batteries can be manually pulled out of their positions within the mechanism's section of each PLS and charged at the ECCS. Additionally, after each predetermined rental period, the batteries can be manually pulled from their positions and placed in the ECCS to be charged. Prior to the beginning of the next rental period, the removed batteries are replaced with fully charged batteries that have been charged at the ECCS or brought from elsewhere. Following the installation of the fully charged batteries, each PLS reboots and idles in an inactive mode, ready to be activated. When it is expected that one or more PLS will be out of use and idle for a long time, the key switch can be used to entirely turn off those PLS.

Although, as mentioned above, the live connectivity of the PLS to a high voltage AC power source is not recommended and may impose a significant liability, this invention also covers an alternative charging option which allows for charging of the PLS's batteries without first removing them from the PLS, using a high voltage AC power source. This charging option can be achieved only when the PLS are not in use. Furthermore, to apply this AC high voltage charging option, a full range of safety rules must be applied, including a proper grounding, the use of proper wires, waterproof connectors, ground fault circuit interrupter (GFCI)-type outlets and breakers, and any other type of waterproof junction boxes and electrical components.

In certain situations, an AC-powered system which includes a transformer that reduces the sourcing voltage may be used to charge the batteries or to directly operate the PLS. In such a scenario, the intake of the high voltage AC source may be connected to an external or a built-in internal waterproof device, which internally contains a voltage reduction transformer. The output of this device provides low voltage AC or DC power, which is used to operate the PLS. In addition to the implementation of all safety measures, such transforming device is fully isolated to protect against electrocution of a person who operate the PLS.

It is also possible to use an external low voltage DC central power source system to operate one or multiple PLS. Under this alternative, the DC low voltage power source can be permanently connected to the PLS or can be connected only when it is used to charge the internal batteries.

Regardless of the charging method used, if a PLS's battery is drained during a rental period, a fully-charged replacement battery can be easily installed. Each PLS can accommodate the placement of one or more batteries. At least one battery is always connected to the PLS's electrical system, while the other batteries may be connected in parallel or just stored as alternate batteries. Fully charged batteries may also be available in slots within the ECCS or within other secured nearby storage areas.

The PLS's structure is designed to protect the user from an electric shock. A water isolation configuration and liquid drainage mechanism are included to eliminate liquid from entering into the mechanism sections of the PLS and to avoid an electric shock to the user. All the PLS's internal electrical elements are operated using low voltage electricity and are concealed within waterproof enclosures.

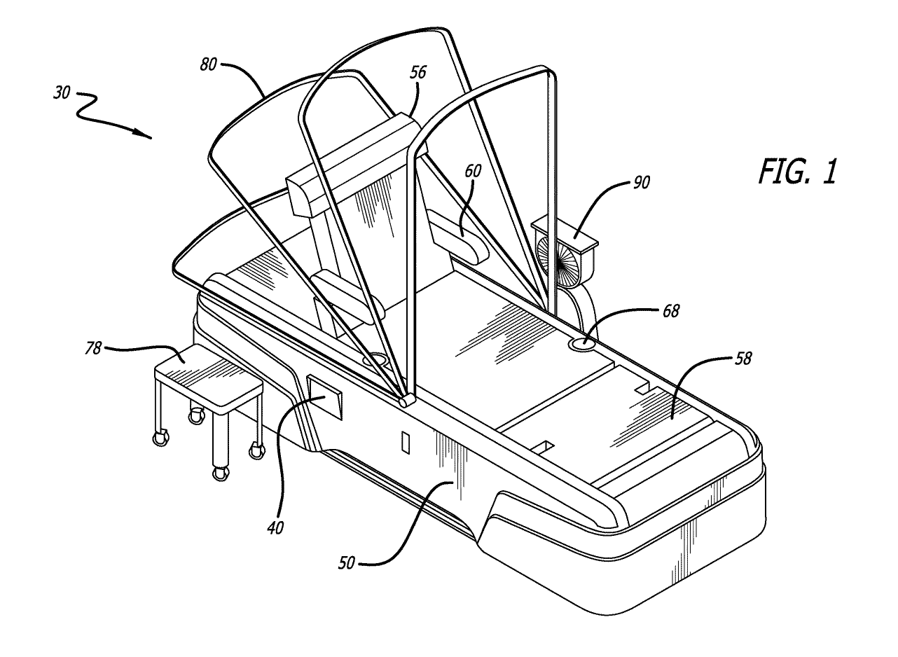

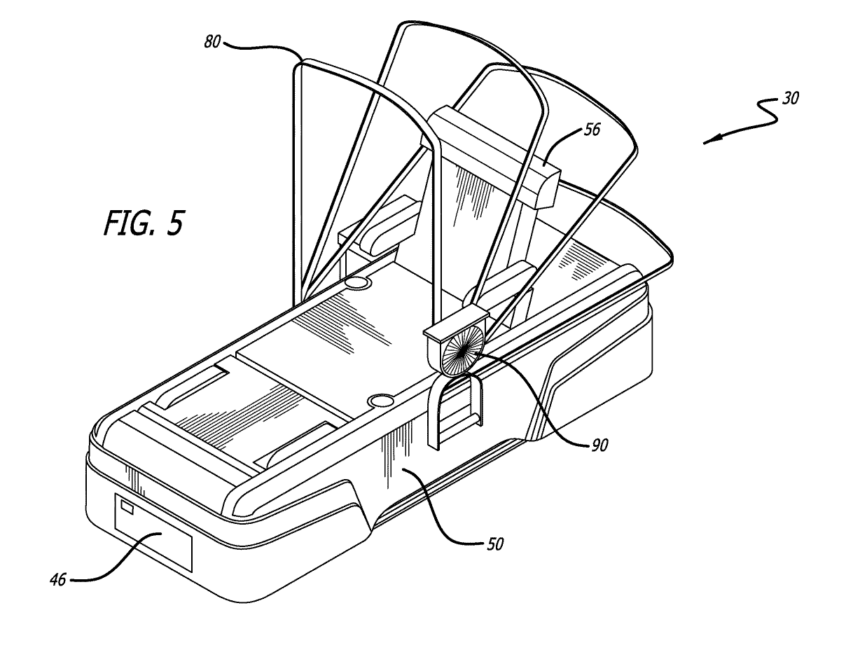

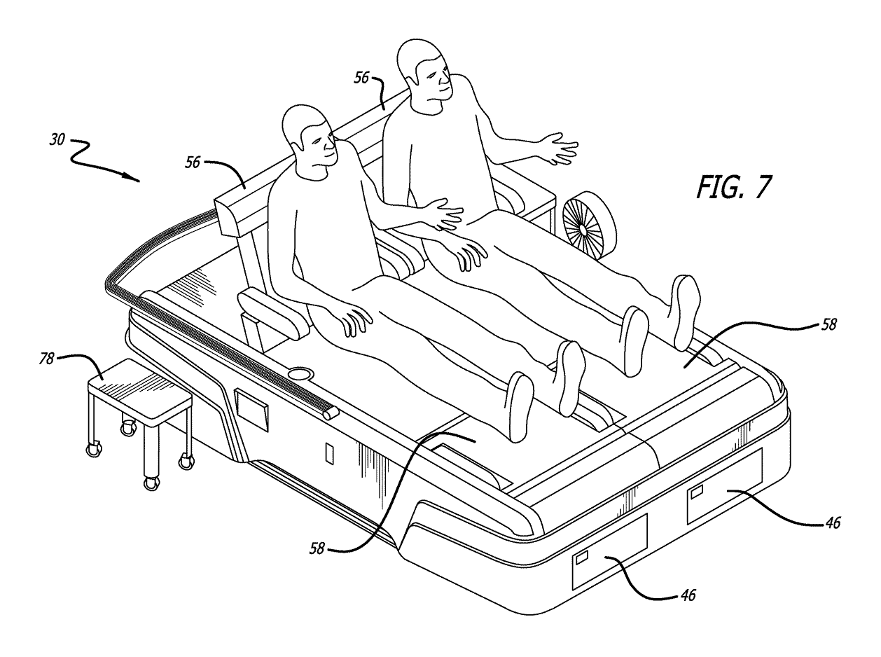

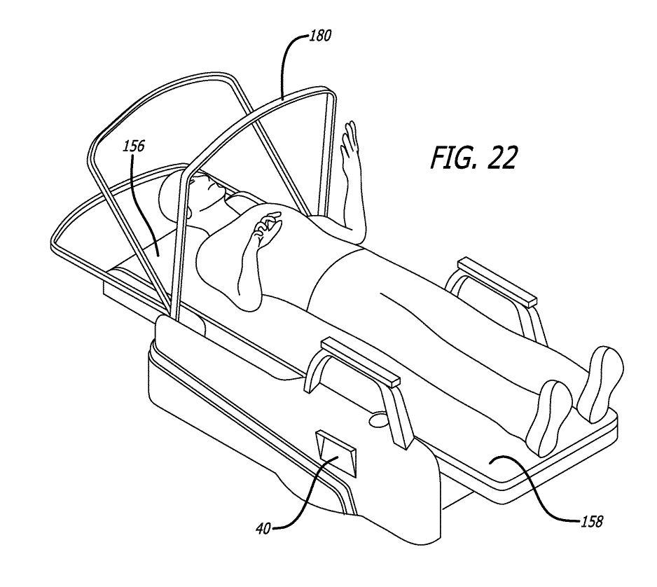

Referring now to the Figures, the PLS 30 in its first embodiment (lounge chair) can be built to accommodate a single user, as illustrated in FIGS. 1-6, or to accommodate two people who are sitting adjacent to each other, as illustrated in FIGS. 7 and 8. The PLS in its second embodiment (recliner), as illustrated in FIGS. 21 and 22, can typically accommodate one person. As described below, the lounge chair and recliner include identical features unless otherwise stated.

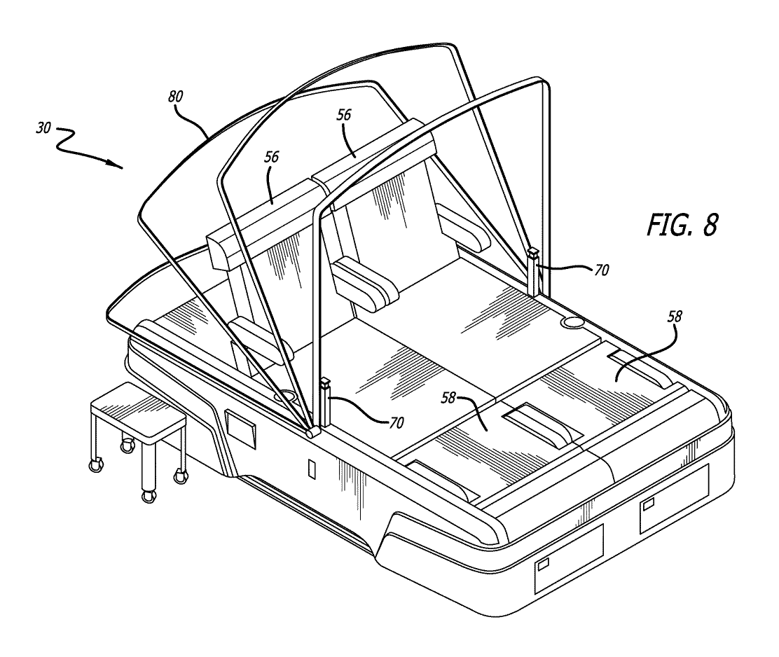

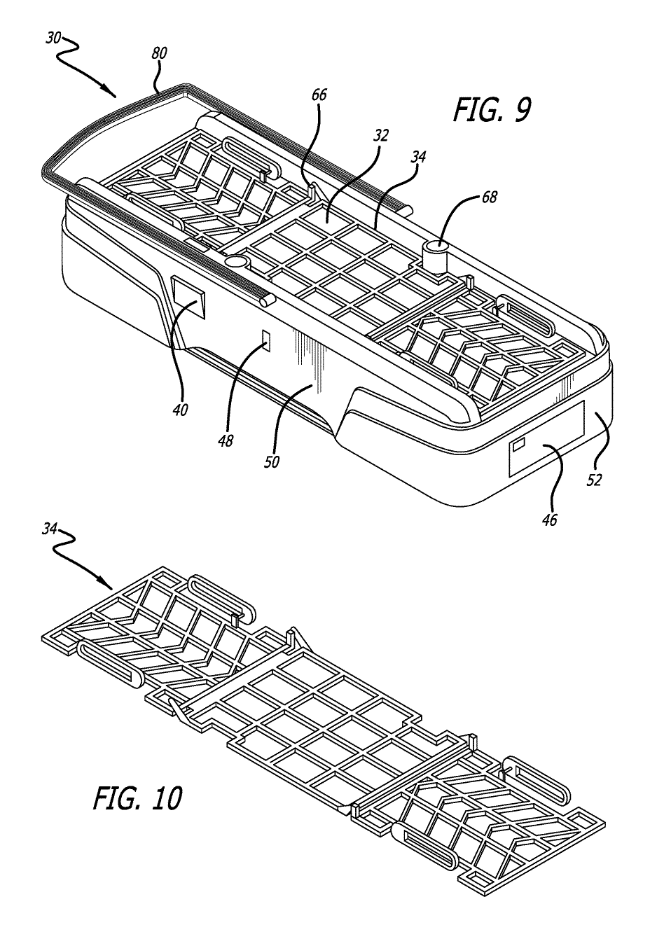

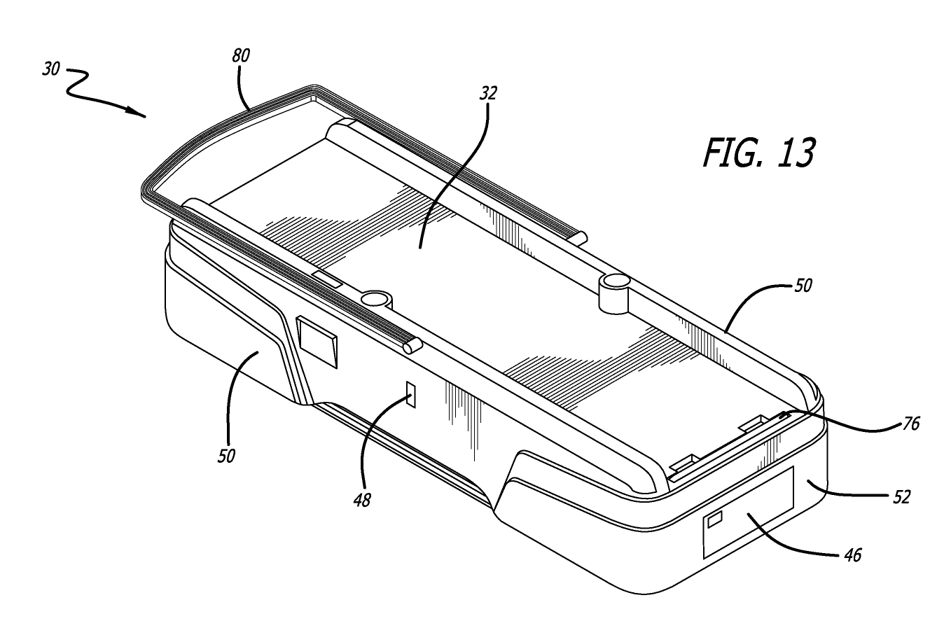

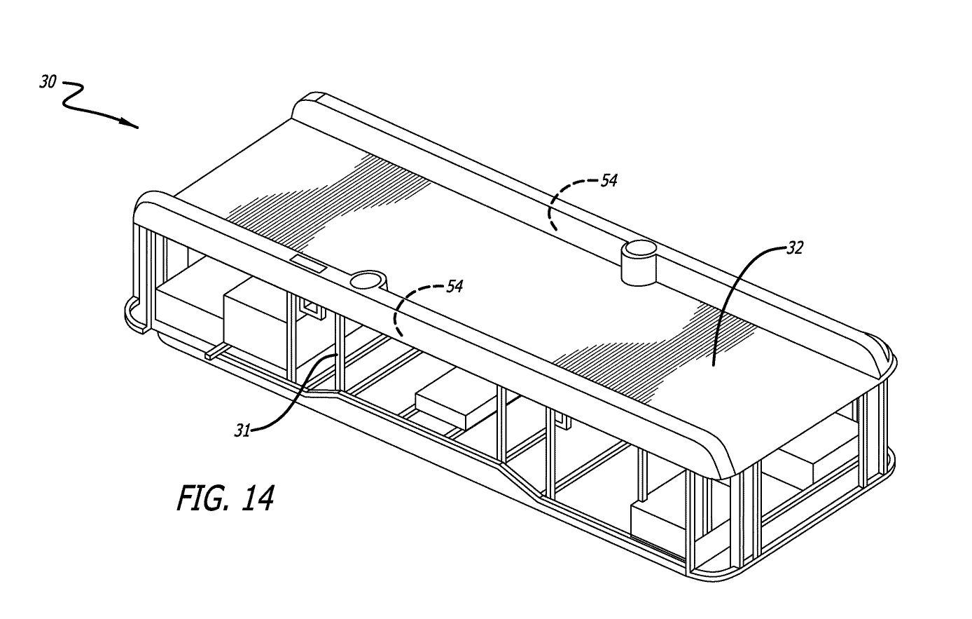

Each PLS's structure contains three main layers. The bottom layer is the main frame structure 31 (see FIG. 14), the middle layer is the top skin or upper skin 32 (see FIG. 14), and the top layer is the laying-deck 34 (see FIGS. 9 and 10). Referring to FIGS. 13-16, the main frame structure 31 consists of assembled or welded metal structural beams, forming the lounge chair's structural shape. A wheeling system 36 with casters is installed underneath the main frame structure. The recliner may also have a suitable frame structure and a central pivoting base that allows the recliner to swivel. Multiple panels are used to create the floorboard and several internal designated compartments 38 within the interior section of the main frame structure. Such panels may be made from a waterproof material to avoid water penetration and to isolate and protect the components within them. The interior compartments are designated specifically for the placement and support of the PLS's operating components and other parts. Among other items, such components and parts include the PLS's electrical and electronic system, the motors, the main control panel or screen 40, the rechargeable batteries, the air flow/AC cooling system 42, the insulated water tank 44, the water and air pumps, the lock-box 46, the icebox 47 and other needed components or parts. The access to these components and parts are through designated doors 48, located in the PLS's side and edge skin panels 50 and 52.

Still referring to FIG. 14, the second layer is the upper skin 32. The upper skin is designed to isolate water or other liquid from penetrating into the interior part of the PLS 30, in order to avoid electrical shorts and potential electrocution of the user of the PLS. The upper skin 32 is installed on the top surface of the main frame structure of the lounge chair, and it is designed to conceal the top of the main frame structure 31 and to force surface water or liquid waste to travel to the built-in drainage system 54 on each side of the lounge chair. The upper skin is made from a water proofed material and it is bolted to the main frame structure. Similarly, the upper skin of the luxury recliner illustrated in FIGS. 21 and 22 is designed to isolate water from its base and its mechanical compartments and to force liquid to travel to the outside.

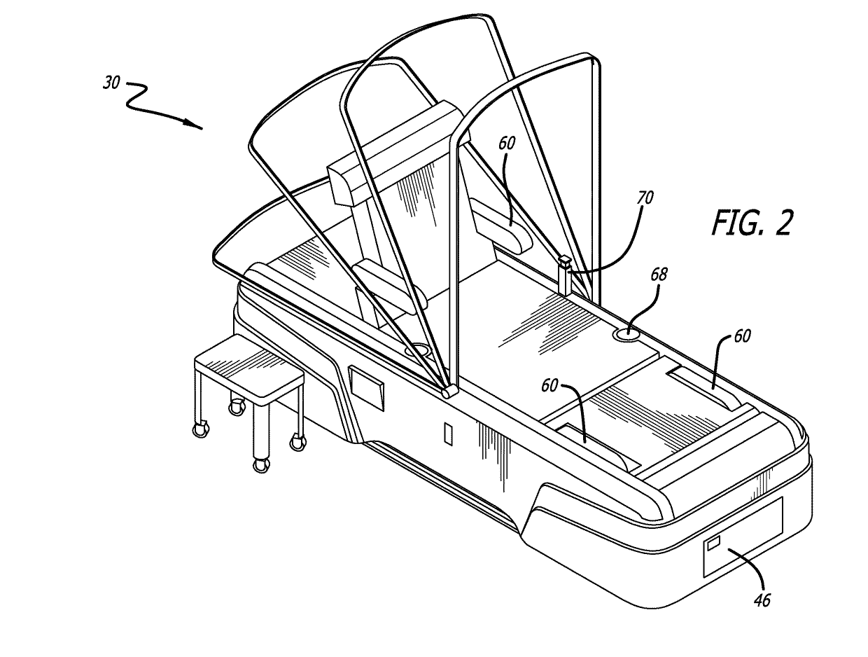

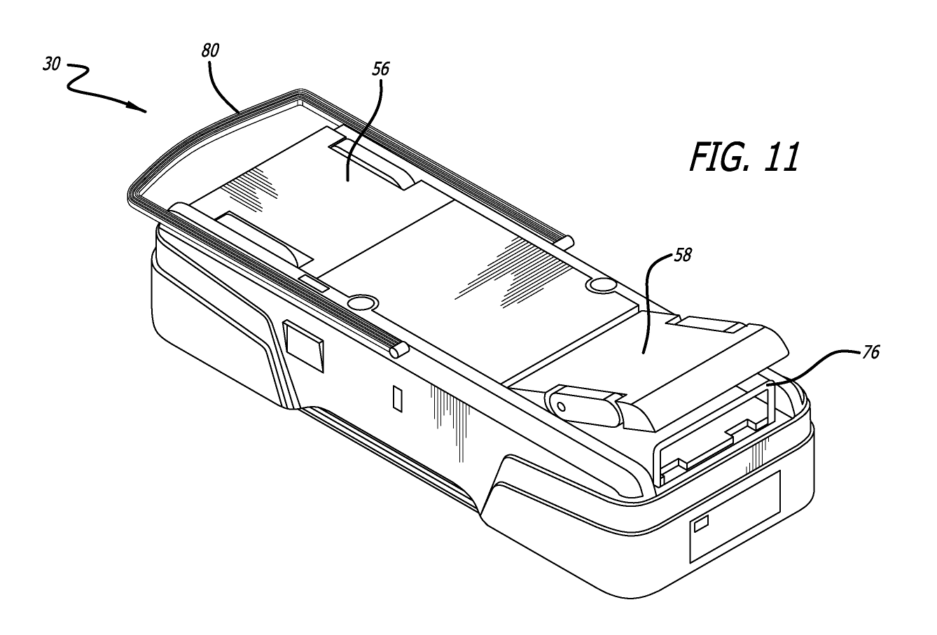

Referring to FIGS. 1, 2, 9 and 10, the third layer is the laying-deck 34. The laying-deck 34 of the lounge chair consists of the laying-deck's surrounding frame (see FIG. 10), the laying-deck's cushion surfaces (see FIG. 11, for example) and one or two backrest frames 56 and 58, each with two adjustable armrests 60. In a PLS 30 with two backrests, as illustrated in FIGS. 1 and 2, a separate backrest is installed in each side of the PLS. This setup allows the user to switch his/her sitting direction, without turning the entire PLS. When the customer's back is resting over backrest 56, the other backrest 58 becomes a leg-rest surface by being placed in its furthest backward position. When the user wishes to change direction, the customer's back will be resting over the other backrest 58 while backrest 56 becomes a leg-rest surface by being placed in its furthest backward position on the alternate side of the PLS. In a double PLS 30, as illustrated in FIGS. 7 and 8, this option allows the two users to choose between facing each other and facing the same direction. In a PLS with only one motorized backrest, the entire front end of that PLS is used as a permanent leg-rest surface.

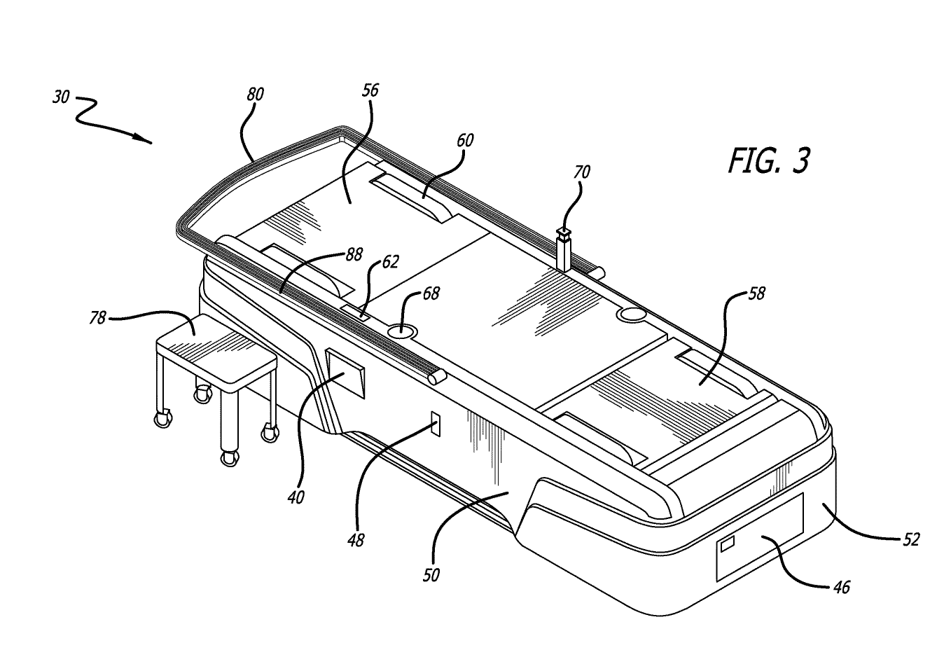

Referring to FIG. 3, each backrest 56, 58 includes two adjustable armrests 60. When a backrest is folded into its furthest backward or lowered position, the armrests are intended to be fully retracted to their highest position, resting in each side of the backrest and creating a flat top resting surface. Such armrests are wrapped on all sides with suitable designed padding that match and blend with the surrounding cushions.

The laying-deck 34 of the recliner illustrated in FIGS. 21 and 22 consists of a back panel or back rest 156, a seating surface and a leg-rest extender 158. Two armrests 160 may be affixed to the sides.

The PLS's motorized system is designed to drive the backrests 56, 58 forward and backward between raised and lowered positions. For example, FIG. 1 illustrates backrest 56 in a raised position and backrest 58 in a lowered position. The user can adjust the backrests to any desired position, using a nearby keypad 62 (see FIG. 3) which activates the motorized system. Each backrest is designed to fold forward to a maximum of a 45 degree angle or to fold backward to a maximum of a 180 degree angle. The operation of the backrests are controlled by the electrical keypad 62 in each side.

The motorized system of the recliner of FIGS. 21 and 22 is designed to drive the back panel 156 forward and backward and to extend and retract the leg-rest extender 158 in order to allow the user to sit on its sitting surface or to recline backward.

Alternatively, the backrests 56, 58, 156 (or leg-rest extender 158) may be equipped with a manual override crank system, air-cylinder or spring mechanism that allows the user to manually place and lock the backrest or leg-rest in a desirable position when the motorized system is not engaged or when the electrical power is drained.

Customized outdoor grade cushions for maximum comfort are placed, affixed, or formed over the laying-decks 34 of the PLS 30. Such backrest cushions may also be designed to provide head and/or legs pillows as well.

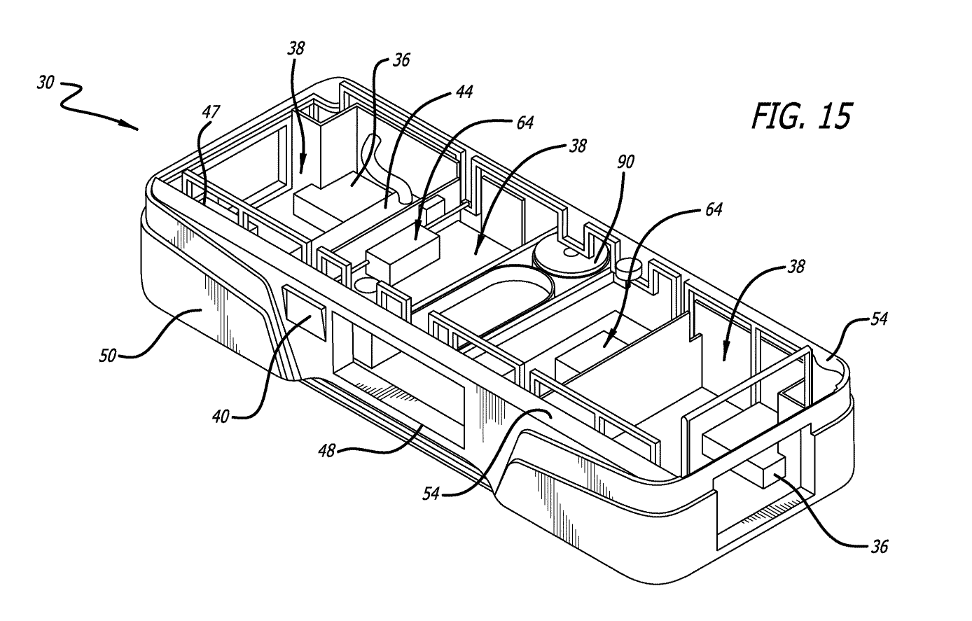

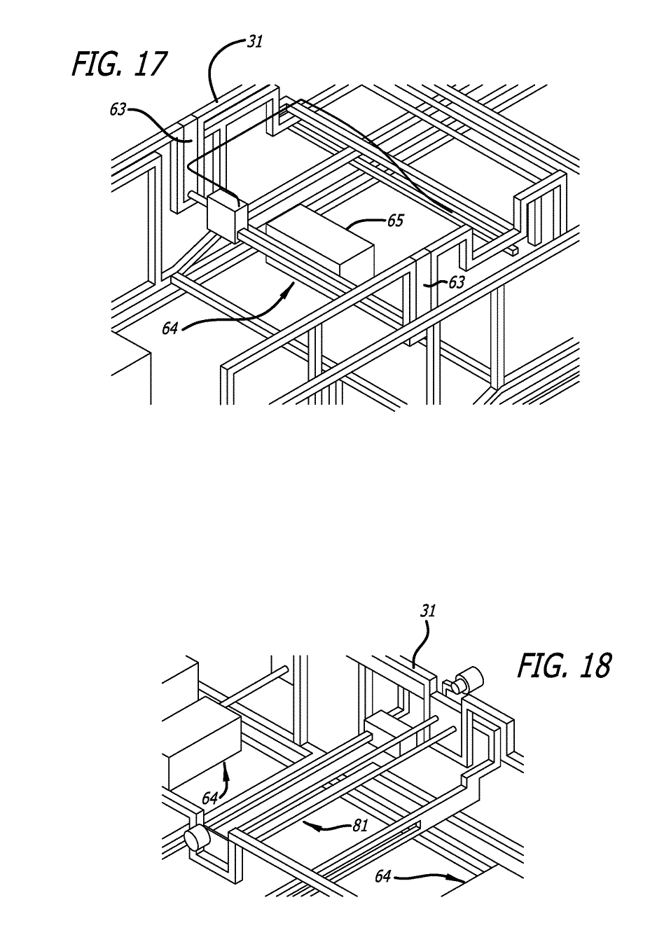

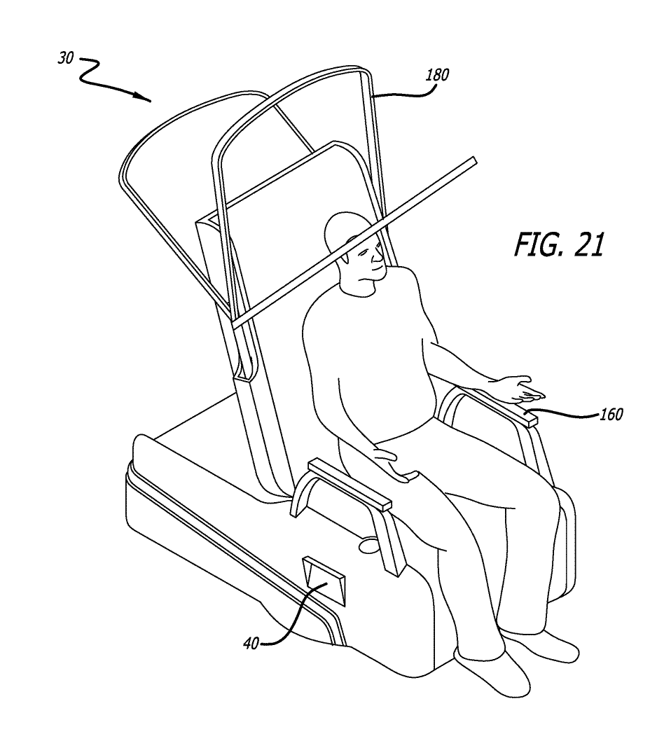

The laying-deck 34 of the lounge chair is positioned above the upper skin 32 and secured into the main frame structure 31 by welds, bolts, nuts, brackets, or other suitable means. When the laying-deck is installed over the upper skin, the gear-shafts 63 of a motorized backrest gear system 64 for both backrests (see FIGS. 15, 17, and 20) is engaged with the motor's 65 gears below at laying-deck gear engagement points 66 (see FIG. 9), in order to drive the backrests forward and backward.

The two side skins 50 and the front and back edge skins 52 are installed and attached to the main frame structure 31 and are used as the overlays of the lounge chair. The skins are formed from a durable material, such as fiberglass, and are customized to fit over the main frame structure of the lounge chair. In addition to the upper skin 32, the two side skins 50 and the front and back edge skins 52 are designed to complete the water isolation requirement and to eliminate water or any liquid waste penetration to the interior part (see FIG. 15) of the lounge chair. These skins are decoratively customized and are used as the outer skins of the PLS 30. The two side skins and the front and back edge skins also consist with access doors 48, allowing accessibility to the components and to the internal compartments 38. The top surface of each side skin contain cup holding cavities 68 (see FIG. 9), the insertions for the operating keypad 62 of the

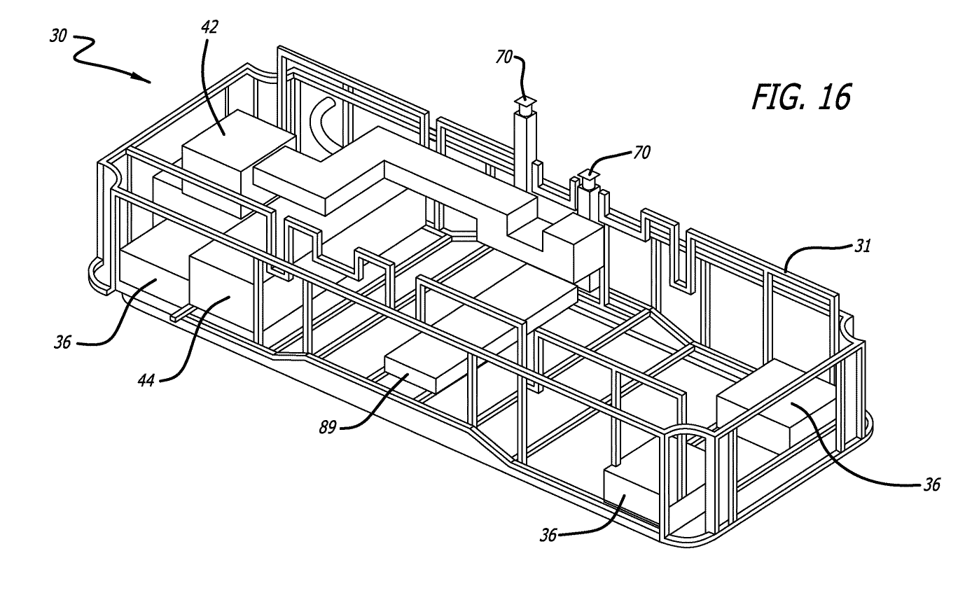

PLS as well as the air vents system 70 (see FIG. 16). The side skins of the recliner operate similarly.

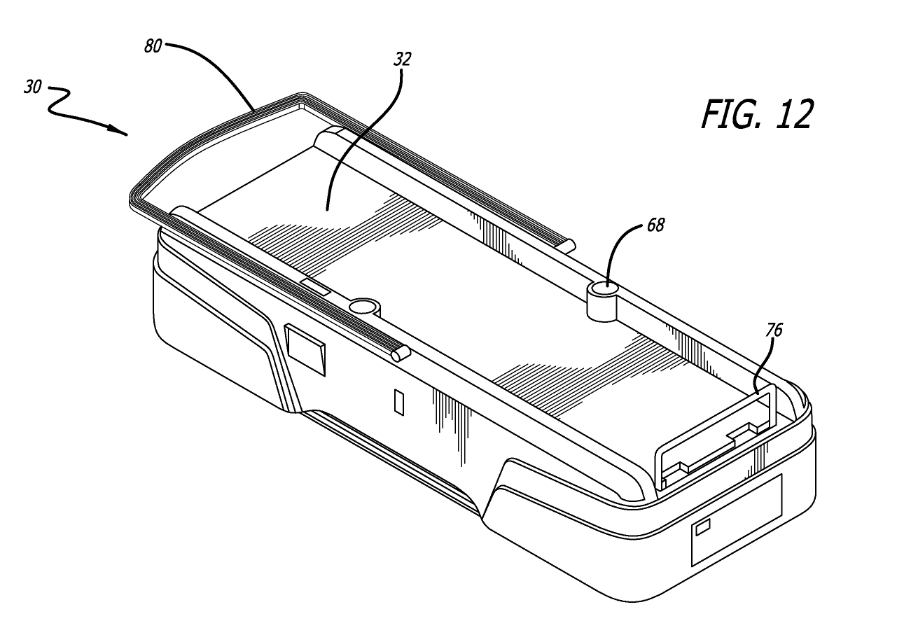

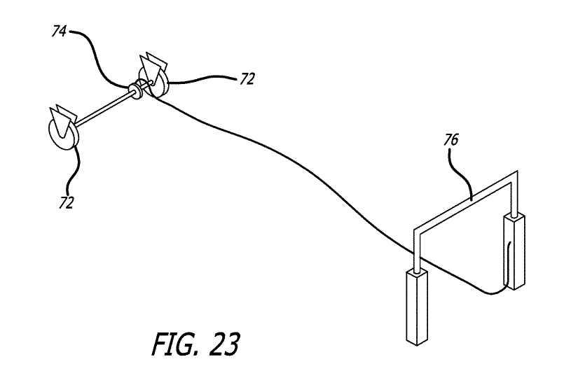

Four or more swivel type casters 72 within the wheel housings 36 (see FIGS. 15 and 16) are attached to the bottom of the main frame structure 31 and may be integrated with a wheel's locking mechanism 74 of the lounge chair (see FIG. 23). The casters may also be electrically operated using a forward-backward switch that installed within a pushing bar handle 76 illustrated in FIGS. 11, 12 and 23. The pushing bar handle is installed in the front end of the lounge, above the locker 46. The pushing bar handle 76 mechanism consists of a telescopic frame, a wheel locking system and electric switch. When the pushing bar handle is pushed down, the wheels are locked and the movement of the lounge chair is restricted. When the handle is pulled up, the wheels are free and the lounge chair can be moved.

An oval shape metal tracking is also attached to the bottom of the main frame structure 31 of the lounge chair in order to host the hook of the nearby tethered side table 78 (see FIG. 1). The tethered side table 78 can be placed in any position around the PLS 30, while it remains tethered to the PLS, at all times. The tethered side table is provided for the comfort of the user. The user can use it for eating, writing, using a computer or for any other needs that the customer may have. This mechanism ensures that each PLS will have a table available at all times and prevent removal of the table from the PLS.

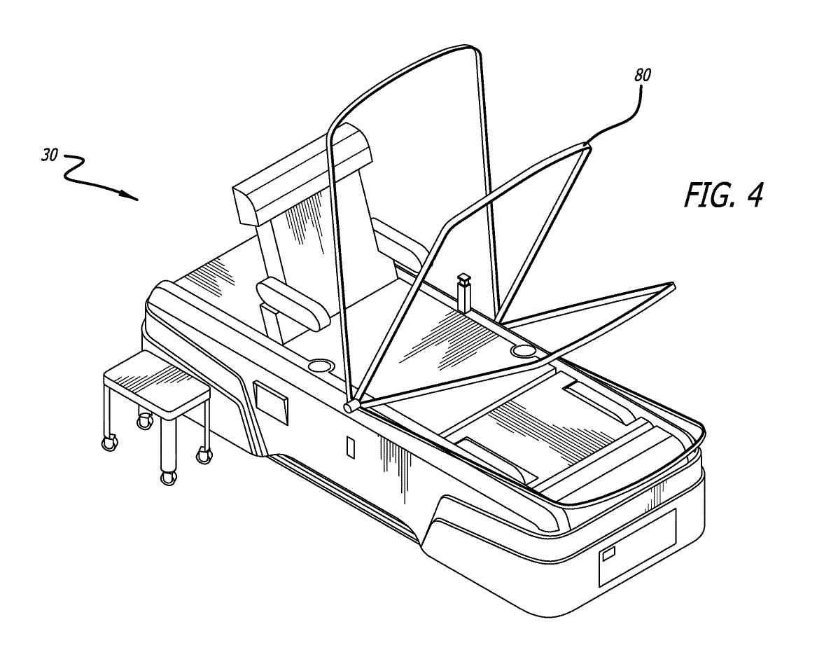

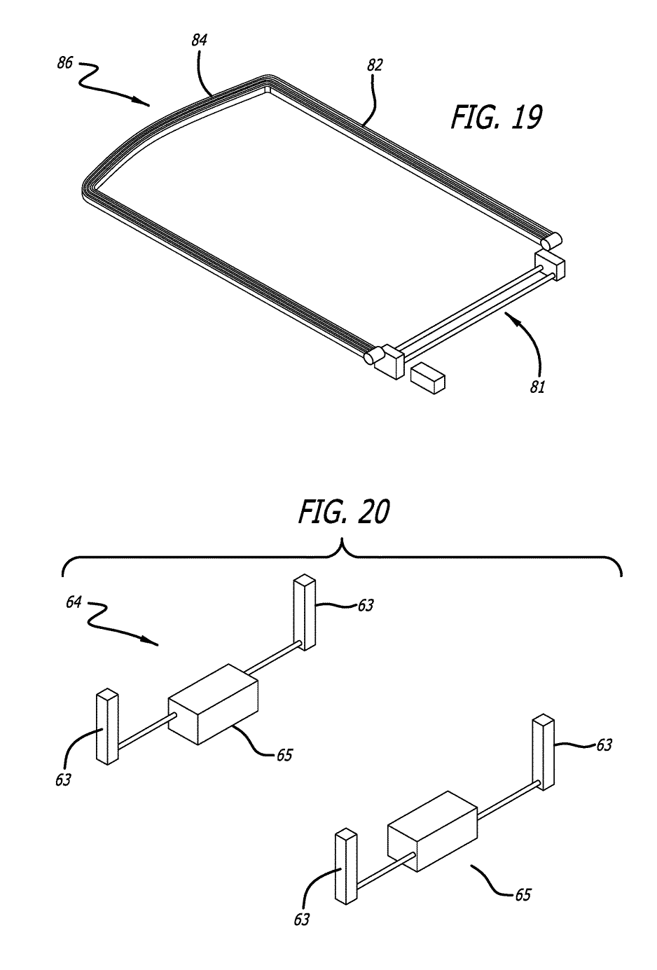

A motorized canopy 80 is installed above the laying-deck 34 of the lounge chair. The canopy pivots in the middle of the PLS 30 and can be used to fully expand or retract from both directions (see FIGS. 1 and 4). The motorized system 81 of the canopy 80 (see FIGS. 18 and 19) is secured to the main frame structure 31 and includes side bars 82 in each side as well as crossbars 84 in between, forming the canopy frame 86. When installed, the canopy's trunks rotating mechanism rests on each side of the PLS. The operation of the canopy 80 is controlled by the electrical keypad 62 in each side of the lounge chair. When the canopy retracts, the canopy's side bars align in the designated trenches 88 (see FIG. 3) that are located on the top surface of each side skin of the lounge chair. Sunshade material extends over the canopy frame 80 to provide protection from the sun. The sunshade material may also apply over the side bars or over a portion or section of the side bars. Alternatively, mesh material may extend over the side bars or over a portion of the side bars of the canopy. The canopy 80 may contain a mist system with at least one nozzle that is connected to the PLS's water tank 44 and to the pumps system located in the mechanism's section. The recliner's canopy 180 of FIG. 21 is similarly installed on the sides of the back panel and can be extended up and down as well as forward and backward. Alternatively, a detachable canopy may be used. Such detachable canopy may be designed to fit and accommodate the configuration and design of the PLS.

The electrical system includes the battery compartment's set up and the PLS's power distribution lines. The power distribution lines are configured to ensure the delivery of power to all components, while the PLS's functions are controlled by user keypad control units.

One or two waterproof operating keypads 62 are installed within the insertions on the top surface of each side skin 50. Each keypad includes the backrest's forward and backward buttons, the canopy' extension and retraction buttons, the airflow/AC system control, the mist on/off buttons, and the service call button, which can be used to send a call for service via the network or just to turn on a service call indicator light. The recliner's keypad is similarly installed on the top surface of the side skin under the armrest.

One or more high capacity DC batteries 89 are situated inside the battery compartment within the components compartments 38 in FIG. 15, inside the main frame structure 31 of the lounge chair (see FIG. 16). The recliner's batteries are secured inside the batteries compartment under the sitting surface. Such battery or batteries 89 are secured within the compartment and are connected to the PLS's electrical and electronic systems. The PLS's batteries are designed to be easily removed and reinstalled so as to allow frequent charging at an external charging station. At least one battery is connected to the PLS electrical system while other batteries may be connected in parallel or stored as alternate batteries. One or more solar panels may be added to continually charge the batteries, while being under the sun.

The PLS 30 may include a telescopic or non-telescopic fan 90, such as that illustrated in FIG. 1, which is placed along the side of the PLS. Such fan 90 can be raised or retracted (see FIG. 15) by a motorized system, or manually. The fan may be installed within a square or U-shape frame, allowing the user to tilt and adjust it to accommodate the desirable air-blowing direction. The telescopic fan may contain a mist system with one or more nozzles, connected to the water tank 44 and to the pumps system located in the mechanism's section. The mist functions can be turned on only when the fan is on.

Alternatively, a reversible fan or blower may be installed within an enclosure in the mechanism section which is designed to draw air in from the outside and push it through flexible tubing to air-diffusers vents 70 (see FIG. 16) that are installed on each side of the PLS 30. Such air-diffusers vents can be installed on a swiveling telescopic pipe and allow the user to manually adjust the direction of the airflow. A swamp cooling system or a compact AC system 42 can also be integrated to cool the blown air.

The PLS 30 may also include an installed lock-box 46. The lock-box is framed and secured within the main frame structure 31, in the front end of the PLS. The lock-box's integral door includes a mechanical, electrical or electronic type locking system that can be easily programmed by a user, utilizing a selected numerical code, fingerprint, RFID code or any other suitable locking system method. The PLS may also include an ice-box 47 or mini refrigerator that may be framed and secured within the main frame structure 31 of the PLS. A similar fan and cooling system as described above may also be installed in the recliner.

The electronic system components are securely placed within the mechanism's compartments 38. The electronic system consists of one or more programmed printed circuit boards, a computerized unit, and a computerized display screen. Multiple contact switches, limit switches sensors, and pressure sensors are also integrated and controlled by the electronic system. The computerized unit may be a tablet PC or an independent minicomputer that includes or connects to an external clocking mechanism, and may include a wireless card and/or a mobile broadband modem.

The computerized display screen is installed onto the control panel 40 that is attached to the PLS's side skin 50. The control panel also includes the on/off key switch, which is used to turn the PLS's electronic system on or off, a USB connector or any other connector types that can be used by the customer to charge the batteries of personal devices, such as laptop, mobile phone, tablet, etc. and universal connectors to connect handheld devices to the PLS's speaker system. Additionally, the control panel may also include a barcode/QR reader, a credit/debit card reader and RFID/NFC detectors. An internet hot spot may also be provided by the electronic system.

Another fundamental aspect of this invention is the ability to rent the PLS 30 on a “time of use” basis. Although in homes or in other private facilities the use of the PLS will likely be free of charge, the PLS can be rented for a fee in public facilities, such as hotels, clubs, cruises, etc.

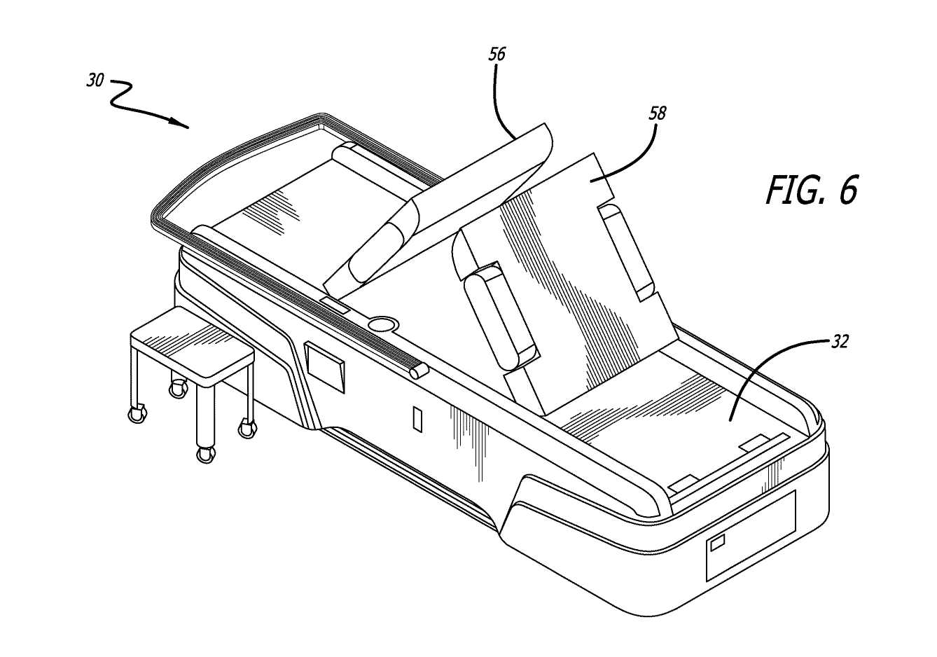

In most public locations, a basic rental procedure will apply under which the customer reserves online specific PLS unit(s), for certain dates, or uses the assistance of the facility's designated staff to rent the PLS(s). Upon securing the customer's payment, the facility's designated staff hands the proper On/Off keys for the rented PLS(s) to the guest. On the proper date(s), the guest approaches the assigned PLS(s) and uses the keys to turn it on. At the end of the rental time, the guest turns off the PLS and returns the keys to the facility designated staff. When the PLS is turned off, it is automatically switched to shut off mode. At that time, its backrests or back panel may automatically move to their furthest frontward preset position (see FIG. 6) and the PLS's electrical functions become disabled. The furthest frontward locked position of the backrests intends to restrict the use of the PLS while it is in shut off mode.

In order to minimize the involvement of facility designated staff and to allow a fully automated rental and activation process, an electronic rental and activation procedure can apply under which the PLS(s) can be reserved and assigned online using a network's website. The customer or customer's agent can access the network's website to reserve one or more available PLS, for specific date(s), within a particular location. After selecting the location (such as a hotel or resort), the website displays a list or an illustration that specifies the available PLS, within the desired location, for the requested date(s). At that time, the customer selects the desired available PLS(s) and confirms the selections for payment. Payment can be made using a credit/debit card online, or if the reservation was booked by the hotel, club, cruise etc., the charge can be applied to the hotel account while the guest's room account is charged accordingly. Vouchers, coupons, etc., can also be used to reserve the PLS. After the payment is confirmed, a receipt/reservation slip is created that lists the reserved PLS's location names, the PLS identification (ID) numbers and the coordinate authorization code, and the date of use of each code. Upon successfully reserving the PLS(s), an activation code for each PLS for a specific date of use is provided. Each authorization code is used to activate one particular PLS on such a predetermined date. The authorization code can be in the form of digits, which can be manually entered into the PLS's control screen, or it can be in the form of a barcode or a QR code that can be scanned using an integrated scanner in the PLS.

The network's interactive website allows the PLS's operator to conduct online reservations and facilitate payments, as well as to facilitate the promotion and marketing of the PLS. Additionally, the network allows the PLS's operator to obtain reports and conduct other administrative functions as needed. During a standby mode, the electronic system's control screen is in hibernation mode until the screen is touched. At that time, the screen turns on, showing the PLS ID number, the current date and time, a numeric keypad, and short instructions that describes how to activate the PLS. After few second of inactivity, the screen shifts to sleep mode and few second later to hibernation mode, in order to save energy.

When the electronic rental and activation procedure is used, the PLS's electronic system activates the PLS's mechanism once an authorization code, which is given to the customer at the time of payment, is accurately entered into the PLS's control system. Therefore, the activation of a PLS can only be accomplished after the correct authorization code is entered into the correct PLS ID, at the correct date of use. To enter the authorization code, the customer begins by touching the PLS's control screen. The control screen is turned on and displays its interactive activation screen. The interactive activation screen includes the current date and time, the PLS ID number, the location name, a numeric keypad and short instructions that describe the activation process. Upon the successful entry of the authorization code, the PLS is activated and all functions become available to be used. When the PLS is not rented, the PLS idles in inactive mode, its functions are off and the PLS's use is restricted. Once the authorization code is entered, the PLS becomes active and is ready for use.

Each PLS 30 includes a computerized unit (the electronic system) that controls its functionalities. The electronic system, when connected to a Wi-Fi or cellular connection, can also communicate with the main central network servers (the network) in real-time.

Each PLS is identified by its own unique PLS ID number and these numbers are synchronized with the PLS(s) listed in the network's database.

The PLS's control system confirms the authorization code that is entered in real-time, using the network, and then activates the PLS. Once activated, the electrical system turns on and the backrests automatically shift to the furthest backward position or to any other pre-set position, and all the PLS's functionalities become available.

When a cellular or Wi-Fi connection is not available or if the operator of the PLS does not wish to be dependent on any wireless connectivity, the verification of the authorization code can be achieved by using a local verification procedure (LVP), under which the PLS locally confirms that the authorization code entered by the customer matches one of the codes that were pre-saved or previously embedded on its internal electronic system for the same predetermined “date of use”. To determine the correct date and time, the PLS utilizes its own computerized built-in clocking system or a distinct clocking mechanism. One or more codes can be saved or embedded for each particular “date of use” and any one of them can be used to activate the PLS, at that particular date.

An integration can be made to allow PLS(s) that are placed in hotels, clubs, cruises, etc., to be activated using the facility's room-key or any other RFID or NFC device, as well as other electronic means that are associated with the guests' room number or any guest's pending account at the facility.

In some cases, the PLS may also include a built-in credit or debit card reader and/or RFID/NFC detection devices, which allow the customer to self-pay directly upon approaching the PLS, using Debit/Credit Card, RFID/NFC hand devices or smart phone applications. These payment methods can be used when a reservation has been made without an accompanying payment, or when the PLSs are available on a first-come-first-serve basis. In this situation, no authorization code is required.

Coupons and vouchers can also be used to activate the PLS. Upon approaching the PLS, the coupons' or the vouchers' barcodes or QR codes must be scanned by the PLS's scanner. If a digit code is available, it can be manually entered into the PLS's control screen to activate it.

When the electronic rental and activation procedure is used, the activation and the deactivation process are controlled by the PLS electronic system. When the PLS is in use, it is in active mode and all of its functionalities are on. When the PLS is not in use, it idles in inactive mode.

Following a day of rental, and at a predetermined time, the PLS starts its automated process of deactivation. At that time, its backrests automatically move to their furthest frontward preset position and the PLS's electrical functions become disabled. The furthest frontward locked position of the backrests, intends to restrict the use of the PLS while it is in inactive mode.

Each PLS 30 consists of one or more pressure sensors (not shown) that are positioned within the laying-deck 34. If the PLS detects a person sitting or laying over the laying-deck during the deactivation process, the electrical functions will still be disabled, but the backrests will not move to the furthest frontward position at this point. An alert will sound and continue until the person gets off the PLS. At that time, the backrests automatically move to their furthest frontward positions and lock, thus restricting the use of the PLS until the next activation. Alternatively, such deactivation process may not be implemented, where after the basic rental procedure applies, the PLS may become inactive upon turning off the key switch.

Alternatively, during the deactivation process the PLS's backrests can be moved to any predetermined position and a constructed obstacle can be risen or swung to a position that prevents the use of the PLS while it is in an inactive mode.

In some cases, subject to the management instructions, following the deactivation of the PLS, the basic use of the inactive PLS may not be restricted. In this scenario, the PLS's electrical functionalities are turned off, and the backrests are locked in a pre-set position, thus allowing a person to sit or lay over the laying-deck, without restriction.

Following the PLS deactivation process, the battery charging and replacement, maintenance and cleaning tasks begin. At that time, a staff member checks the charge level status of all batteries and removes the weak batteries from their slots in each PLS. The removed batteries are placed in the external charging station to be charged. Fully charged batteries can be taken from the charging station to replace the drained batteries that were removed from the PLSs. Additionally, following the deactivation process, a staff member services the PLS and cleans them to prepare them for the next rental period. Customized covers may be used to protect the PLS when the PLS is not in use.

When the basic rental procedure applies or when the use of the PLS is free of charge, the PLS can be activated or deactivated by using the ON/OFF key switch. When the PLS is placed in a private residence or other private facilities where payment for the use of the PLS is not required, the payment's verification portion of the control system can be eliminated or can be switched to a free-use setting or the PLS can be activated/deactivated by only using its on/off key.

Although several embodiments have been described in detail for purposes of illustration, various modifications may be made without departing from the scope and spirit of the invention.

What is claimed is:

1. A poolside lounger comprising:
a main frame structure;
a laying deck disposed above the main frame structure, the laying deck including at least one motorized backrest, the at least one backrest moveable between a raised position and a lowered position;
a keypad configured to enable movement of the at least one motorized backrest between the raised and lowered position; and
a control panel configured to enable the keypad and use of the poolside lounger in response to activation from a user.

2. The poolside lounger of claim 1, wherein the at least one motorized backrest includes adjustable armrests.

3. The poolside lounger of claim 1, further comprising an upper skin and side skins covering the main frame structure, the laying deck being disposed on the upper skin.

4. The poolside lounger of claim 1, wherein the upper skin isolates liquid from penetrating the interior of the poolside lounger.

5. The poolside lounger of claim 1, wherein the at least one motorized backrest comprises a first motorized backrest and a second motorized backrest arranged on opposite sides of the poolside lounger, the first motorized backrest and second motorized backrest being adapted to serve as leg rests in their lowered positions.

6. The poolside lounger of claim 1, wherein the at least one motorized backrest is configured to fold forward at maximum 45 degrees and to fold backward at maximum 180 degrees.

7. The poolside lounger of claim 1, wherein the at least one motorized backrest is moveable in response to one of the keypad, a manual override crank system, air-cylinder, or spring mechanism.

8. The poolside lounger of claim 1, further comprising a motorized canopy pivotably mounted to the poolside lounger.

9. The poolside lounger of claim 1, further comprising a detachable canopy that is designed to fit and to accommodate the configuration of the poolside lounger.

10. The poolside lounger of claim 1, further comprising at least one compartment within the poolside lounger which is accessible through an access door in a side skin of the poolside lounger.

11. The poolside lounger of claim 10, further comprising a lockbox in the at least one compartment within the poolside lounger.

12. The poolside lounger of claim 10, further comprising a motorized fan retractable inside the at least one compartment within the poolside lounger.

13. The poolside lounger of claim 10, further comprising an ice box in the at least one compartment within the poolside lounger.

14. The poolside lounger of claim 1, wherein the poolside lounger includes a USB charger or other charger type for charging handheld devices, speakers, internet connectivity, and a waiter service calling mechanism.

15. The poolside lounger of claim 1, further comprising an air conditioning system disposed within the main frame structure and including at least one air condition vent projecting upwardly through the poolside lounger.

16. The poolside lounger of claim 1, further comprising a side table tethered to the poolside lounger.

17. The poolside lounger of claim 1, wherein the poolside lounger includes cup holding cavities.

18. The poolside lounger of claim 1, further comprising a water drainage system disposed within the poolside lounger.

19. The poolside lounger of claim 1, further comprising a water tank disposed within the poolside lounger.

20. The poolside lounger of claim 19, wherein the poolside lounger includes a mist system connected to the water tank.

21. The poolside lounger of claim 1, further comprising a plurality of wheel housings containing casters disposed underneath the poolside lounger.

22. The poolside lounger of claim 21, further comprising a push bar handle extending from a front end of the poolside lounger, the push bar handle being configured to lock the casters when pressed downward to prohibit movement of the poolside lounger.

23. The poolside lounger of claim 1, wherein the poolside lounger is operated utilizing one of at least one low voltage, externally rechargeable DC battery or a direct, external low voltage DC source system.

24. The poolside lounger of claim 23, wherein the at least one battery is rechargeable through an external central charging station.

25. The poolside lounger of claim 1, wherein the poolside lounger is operated utilizing a low voltage AC power source transformed via a voltage reduction transformer.

26. The poolside lounger of claim 1, wherein the control panel includes at least one of an on/off switch, a USB connector or other connector alike to charge handheld devices, a barcode reader, a QR reader, a credit card or debit card reader, a RFID detector, or a NFC detector.

27. The poolside lounger of claim 1, wherein activation of the poolside lounger is achieved through the control panel using one of an on/off key switch, a room key, a RFID device, a NFC device, a credit card, a debit card, a smartphone application, a coupon, or a voucher.

28. The poolside lounger of claim 1, wherein the poolside lounger is rentable by a user at a predetermined date and time as part of a manual rental procedure, and wherein the manual rental procedure comprises the user reserving the poolside lounger at the predetermined date and time, providing payment, and activating the poolside lounger to be fully functional through the control panel with an on/off key at the predetermined date and time.

29. The poolside lounger of claim 1, wherein the poolside lounger is rentable by a user at a predetermined date and time as part of an automated rental procedure, and wherein the automated rental procedure comprises the user reserving the poolside lounger on a website over a network at the predetermined date and time, providing payment, and activating the poolside lounger to be fully functional through the control panel using an authorization code including one of numerical digits, a barcode, or a QR code.

30. The poolside lounger of claim 29, wherein the authorization code is confirmed over the network or using a local verification procedure, wherein the local verification procedure comprises confirming the received authorization code using codes saved in an internal electronic system of the poolside lounger.

31. The poolside lounger of claim 1, wherein the at least one motorized backrest projects forward in an inactive mode limiting use of the poolside lounger until activation from a user is received into the control panel.

32. The poolside lounger of claim 31, wherein the laying deck includes a mechanism for detecting if the user is lying on the poolside lounger which prevents the at least one backrest from projecting forward until the user is no longer detected on the poolside lounger.

33. The poolside lounger of claim 1, wherein the poolside lounger is covered when not in use.

34. The poolside lounger of claim 1, wherein the poolside lounger is adapted to seat multiple users.

35. The poolside lounger of claim 1, wherein the poolside lounger is one of a lounge chair or a recliner.

36. A poolside lounger comprising:
a main frame structure including an upper skin and side skins;
a laying deck disposed on the upper skin, the laying deck including at least one motorized backrest, the at least one backrest moveable between a raised position and a lowered position;
a motorized canopy pivotably mounted to the poolside lounger;
a keypad configured to enable movement of the at least one motorized backrest between the raised and lowered position; and
a control panel configured to enable the keypad and motorized canopy and use of the poolside lounger in response to activation from a user;
wherein the poolside lounger is rentable by the user and electrically operable by a pool.

37. A poolside lounger comprising:
a main frame structure including an upper skin and side skins;
a laying deck disposed on the upper skin, the laying deck including a first motorized backrest and a second motorized backrest arranged opposite to each other, the first and second motorized backrests each moveable between a raised position and a lowered position;
a motorized canopy pivotably mounted to the poolside lounger;
a plurality of compartments within the poolside lounger which are accessible through the side skins of the poolside lounger;
a lockbox in one of the compartments within the poolside lounger;
a motorized fan retractable inside one of the compartments within the poolside lounger;
an air conditioning system disposed within the main frame structure and including at least one air condition vent projecting upwardly through the poolside lounger;
a keypad configured to enable movement of the at least one motorized backrest between the raised and lowered position; and
a control panel configured to enable the keypad, motorized canopy, lockbox, motorized fan, air condition system, and use of the poolside lounger in response to activation from a user;
wherein the poolside lounger is powered by at least one DC battery and is electrically operable by a pool.
